(19) United States
(12) Patent Application Publication
(10) Pub. No.: US 2024/0116287 A1
(43) Pub. Date: Apr. 11, 2024

(54) PEELING MECHANISM AND METHOD FOR A LAMINATED ELECTRODE

(71) Applicant: Solid Power Operating, Inc., Louisville, CO (US)

(72) Inventors: Colby Lane, Fort Collins, CO (US); A Yang, Erie, CO (US); Uday Kasavajjula, Superior, CO (US)

(21) Appl. No.: 18/377,251

(22) Filed: Oct. 5, 2023

Related U.S. Application Data
(60) Provisional application No. 63/413,532, filed on Oct. 5, 2022.

(51) Int. Cl. B32B 43/00; B32B 37/00; H01M 10/04; H01M 10/058

(52) U.S. Cl. CPC B32B 43/006; B32B 37/025; H01M 10/0404; H01M 10/058; B32B 2457/10

(57) ABSTRACT

A peeling device for manufacturing of an electrode stack includes an upper wedge and a lower wedge between which the electrode stack is fed after a calendering process. A respective lifting roller may be located at the output ends of each of the wedges, which through coordinated action peels the aluminum layers away from the corresponding layer of the electrode stack. The peeling force, exerted by rollers capturing upper and lower aluminum foil sheets of the stack, may be controlled and relatively uniform, thereby enhancing the ability to peel the foil from the stack while not damaging the relatively delicate remaining layers. The aluminum foil is directed away from the stack along an outer planar surface of the respective wedge where the foil can then be wound around the respective rollers.

### CROSS-REFERENCE TO RELATED APPLICATION

This application is related to and claims priority under 35 U.S.C. § 119(e) from U.S. Patent Application No. 63/413,532, filed Oct. 5, 2022, titled “Peeling Mechanism and Method for a Laminated Electrode,” the entire contents of which is incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND AND INTRODUCTION

The ever-increasing number and diversity of mobile devices, the evolution of hybrid/electric automobiles, and the development of Internet-of-Things devices, among other things, is driving ever greater need for battery technologies with improved reliability, capacity, thermal characteristics, lifetime and recharge performance. Currently, although solid-state battery technologies offer potential increases in safety, packaging efficiency, and enable new high-energy chemistries as compared to other types of batteries, improvements in lithium battery technologies and other solid-state battery technologies are needed, especially improvements in lower cost production.

It is with these observations in mind, among others, that various aspects of the present disclosure were conceived and developed.

### SUMMARY

One aspect of the present disclosure relates to a peeling device for manufacturing a battery electrode. The peeling device may include an upper peeler comprising an upper lifting roller on an output side of the upper peeler, the upper lifting roller rotating in a first direction to lift an upper foil layer away from a laminated electrode stack and a lower peeler oriented opposite the upper peeler and comprising a lower lifting roller on an output side of the lower peeler rotating in a second direction, opposite the first direction, to lift a lower foil layer away from the laminated electrode stack.

Another aspect of the present disclosure relates to method for manufacturing a battery electrode. The method may include the operations of laminating an electrode stack comprising a plurality of layers using a pressing device, wherein the pressing device laminates a first solid-state electrolyte (SSE) layer and a second SSE layer to a conductive foil and removing from the electrode stack, using a peeling device, a first carrier film from the first SSE layer and a second carrier film from the second SSE layer.

Yet another aspect of the present disclosure relates to a system for manufacturing a battery electrode. The system includes a pressing device partially separating, through pressure applied to an electrode stack, a carrier film from a solid-state electrolyte (SSE) layer of the electrode stack, a peeling device removing the partially separated carrier film from the SSE layer in a continuous piece; and a collector collecting the peeled carrier film in the continuous piece.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is a diagram illustrating manufacturing a solid-state electrode laminate using a calender press and peeling device, according to aspects of the present disclosure.

FIG. 2A is a diagram illustrating an input end of the peeling device for use in manufacturing the solid-state electrode laminate, according to aspects of the present disclosure.

FIG. 2B is a diagram illustrating an output end of the peeling device, according to aspects of the present disclosure.

FIG. 3 is a diagram illustrating a cross-section view of the peeling device, according to aspects of the present disclosure.

FIG. 4 is an isometric view of wedge of the peeling device, according to aspects of the present disclosure.

FIG. 5A is a top view of the wedge of the peeling device, according to aspects of the present disclosure.

FIG. 5B is a cross-section view of the wedge of the peeling device, according to aspects of the present disclosure.

FIG. 6 is an isometric view of a guide roller of the wedge, according to aspects of the present disclosure.

FIG. 7 is a flowchart of a method for manufacturing a solid-state electrode laminate using a peeling device, according to aspects of the present disclosure.

FIGS. 8A and 8B are diagrams illustrating a notched calender press for manufacturing separated solid-state electrode laminates, according to aspects of the present disclosure.

FIG. 9 is a diagram illustrating manufacturing a solid-state electrode laminate with cut-outs for separate laminated sections, according to aspects of the present disclosure.

FIG. 10 is a diagram illustrating manufacturing a solid-state electrode laminate with notched sections using the peeling device, according to aspects of the present disclosure.

### DETAILED DESCRIPTION

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions, such as a graphite anode. In these anodes, lithium ions are stored by intercalating between planes of carbon atoms that compose graphite particles. Cathodes of such rechargeable batteries may contain transition metal ions, such as nickel, cobalt, and aluminum, among others. Such electrodes have been tailored to confer acceptable performance in modern lithium-ion batteries. However, carbon-based anodes are reaching maturity in terms of their lithium-ion storage.

Traditional electrode manufacturing for lithium-based rechargeable batteries can be a time-consuming and inefficient process. To manufacture a graphite anode, for example, a graphite slurry is produced that includes graphite components, binders, and a solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

This process for generating a dried electrode sheet may result in a high porosity that is detrimental to an efficient operation within a rechargeable battery. Therefore, the sheet is often passed through a calender press device to reduce the porosity of the materials. The pressed electrode sheet may then be cut into desired lengths. For use in a battery cell (such as a cylindrical cell, prismatic cell, pouch cell, and the like), a stack comprising a separator positioned between the anode sheet and the cathode sheet is then produced from the separate cathode sheet, anode sheet and separator. Typical separators use some type of polyethylene material with a ceramic coating to separate the anode and the cathode and prevent shorts within the battery. A liquid electrolyte then surrounds the produced stack within the battery cell.

Each of the multiple steps of the above process to produce the battery stack may introduce inefficiencies or opportunities for flaws to be introduced in the battery design, resulting in shorter battery life or potential for a short within the battery itself. For example, one or more layers of the battery stack may be quite delicate and may tear or break during handling. Further, the graphite slurry coated onto the metal foil may attach to the foil such that separation of the graphite from the foil may be difficult, particularly without damaging other layers of the battery stack. As such, tremendous care is typically required in the manufacturing and handling of battery electrodes to prevent damaging one or more layers of the electrode stack.

Aspects of the present disclosure involve systems and methods of producing an electrode laminate for a battery that includes a solid-state separator layer that may replace a conventional separator layer and liquid electrolyte used in conventional liquid electrolyte battery architectures. In one example, an electrode may comprise a stack of a center electrode layer, a solid-state electrolyte (SSE) layer, and an outer carrier film (such as an aluminum foil layer), which is removed prior to use in a cell. In one implementation, the center electrode layer may be a lithium foil and the layers may be arranged initially in an Aluminum-SSE-Lithium-SSE-Aluminum layer stack. The SSE layer may comprise a sulfide-based solid-electrolyte material and a binder cast onto the aluminum foil. The SSE layer is cast onto an aluminum foil, which may be a sheet of material, that allows for volume production in conjunction with the lithium foil layer. To laminate the lithium foil layer to the SSE layers, the stack may be fed through a calender press device comprising a first roller and a second roller. The rollers exert a compressive force on the stack to press the layers together reducing the porosity of one or more of the materials within the stack (otherwise known as densifying), enhancing material contact, and causing some layers to laminate or otherwise bond.

Following the calender press, the electrode stack may be fed, which may be continuously, through a peeling device configured to peel the aluminum layers from the stack to expose an anode stack that may be further processed into discrete anode sections for use in a battery cell. In general, the outer layer of the stack may include many types of materials, including but not limited to metal foils such as stainless steel, nickel, copper, etc. In some cases, such as copper, the sulfide electrolyte may react with the metallic copper. Thus, these type of foils may use a coating such as a carbon coating on their surface. In other examples, the outer layer may also be non-metallic foils such as mylar, polypropylene, etc. Carbon fiber may also be used as the outer layer of the stack.

Prior to peeling, the electrode stack may be fed between planar faces of a respective upper wedge and a lower wedge. A respective lifting roller may be located at respective output ends of each of the wedges, which through coordinated action peels the aluminum layers away from the corresponding SSE layer of the electrode stack. The peeling force, exerted by rollers capturing the upper and lower aluminum foil sheets coming off the stack, may be controlled and relatively uniform enhancing the ability to peel the foil while not damaging the relatively delicate SSE/Li/SSE anode stack. The aluminum foil is directed away from the stack. In the arrangement with the wedge, the foil is directed along an outer planar surface of the respective wedge where the foil can then be wound around the respective rollers. The lifting roller may pull on the aluminum foil layer to move the laminated electrode stack towards the output end of the wedges such that the aluminum foil carries the tension through the peeling device. After the aluminum layers are peeled, the remaining SSE-Li-SSE stack is moved through the peeling device and is collected to be used in an electrochemical cell. The peeling device therefore provides for the removal of the aluminum foil in a roll-to-roll process without applying tension on the delicate inner conductor foil. In some instances, the inner conductor foil layer may be delicate and prone to tearing when pulled. Through the peeling device, the tension used to move the laminated electrode through the device may be all or mostly be applied to the outer aluminum foil layers, protecting the other layers of the stack.

Other aspects of the present disclosure involve systems and methods for manufacturing an electrode laminate for a battery that includes a solid-state separator layer using a notched calender roller. The roller of the calender press may include a notch in the surface of the roller along its length. During pressing of the electrode stack, prior to peeling the aluminum layers, the notch of the roller, when aligned with the stack, may apply a reduced laminating pressure to the stack of layers to generate a portion of the laminated stack in which the adhesion of the SSE layer to the lithium center foil is reduced. When the aluminum layer is peeled from or otherwise removed from the stack by the peeling device, the SSE layer may stick to the aluminum and be removed together, thereby creating discrete portion of the stack where the aluminum and SEE layer are removed exposing a layer of bare lithium foil corresponding to the shape of the notch. Utilizing the notched roller, alternating sections of an SSE layer followed by a section of bare lithium foil may be generated, which lithium foil zones may define conductive tabs for the electrode comprised of the SEE layers bounding the lithium foil, after peeling the outer aluminum layers. The peeling device may also be configured to remove the SSE layer and the aluminum layer from these lithium foil sections in a similar manner as described above. These and other manufacturing systems and methods are described herein for generating a solid-state electrode laminate for use in a battery configuration.

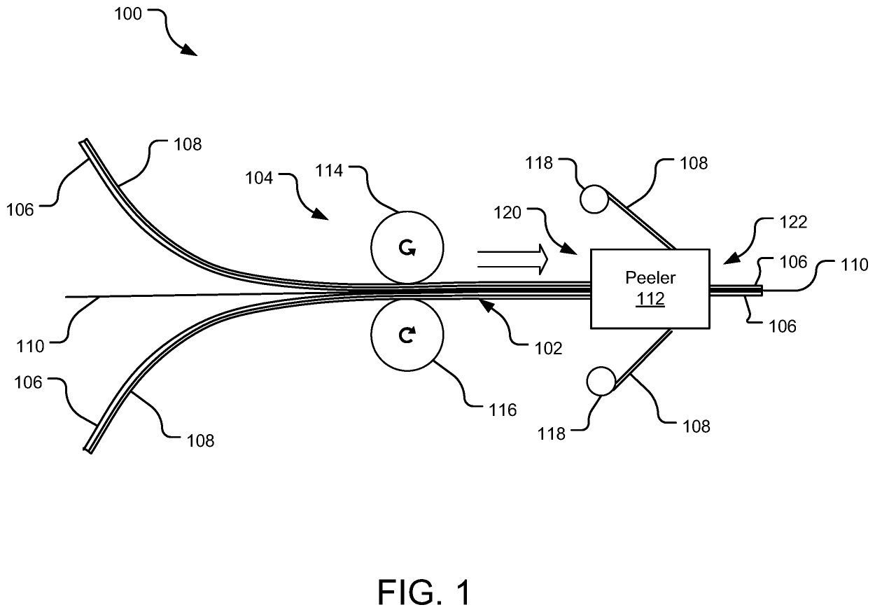

FIG. 1 is a diagram 100 illustrating manufacturing a solid-state electrode laminate 102 using a calender press device 104, according to aspects of the present disclosure. In one implementation, the solid-state electrode laminate 102 may include two separator layers of a composite blend of a solid-state electrolyte (SSE) and a binder. The SSE 106 may be coated as a thin layer on a foil 108. In one example, the foil 108 may be an aluminum foil, although other materials may be used. A thin foil of lithium metal 110 may be placed between two facing SSE layers 106. To generate an anode stack, two different sheets of the SSE 106 on foil 108 may be oriented such that the SSE layers are facing each other with the lithium metal layer 110 between the two SSE sheets. In this implementation, the layers forming the electrode stack 102 are fed between the calender press 104 in an Aluminum-SSE-Lithium-SSE-Aluminum stack. The composite SSE layers 106 in this configuration may conduct ions, but not electrons, during use in a battery such that the SSE layers provide electrical isolation for the middle lithium (or other type of metal) anode layer 110. The respective rollers of the calender press 104 are spaced apart a distance less than the pre-calendered stack thickness such that pressure on the stack being fed between the calender rollers 114, 116 may reduce the porosity of the materials within the stack, enhance material contact, cause some layers to bond, and/or cause a reduction in the adhesion of the SSE layers 106 to the lithium foil 110 layer. The pressure exerted by the calender rollers on the stack may be adjusted through a calender controller, either manually or automatically, by adjusting the space between the calender rollers among other factors, such as the density and type of material of the stack, the pre-densified thickness of the layers of the stack, and the like

As discussed above, conventional lithium-battery anodes are produced by mixing a graphite slurry with multiple ingredients, coating the slurry onto a foil layer, and quickly drying the coated slurry/layer. In contrast, the electrode laminate 102 of FIG. 1 uses a lithium foil 110 with no slurry mixture. Further, the lithium anode 110 is not coated onto a foil as the graphite anode may be. Rather, the lithium anode 110 is laminated between the two SSE layers 106 through the calender press device 104. In some implementations, the anode layer 110 may be of another material, such as graphite, silicon, etc.

The SSE layer 106 may comprise, in some implementations, a sulfide-based material that is cast onto an aluminum foil layer 108. The SSE layer 106 may also include a binder solution and/or a solvent prepared in a slurry form. When making the SSE slurry, one or more solvents may be used and the binder(s) used may or may not be soluble in those solvents. When the binder is not soluble, a “binder solution” is not formed. Also, when the SEE layer 106 is dried, there is no longer a binder solution. Rather, a solid binder that is intimately mixed within the SSE layer remains. This SSE slurry may be mixed, coated onto the aluminum foil 108, and dried. In some implementations, each of the SEE layers 106 may be between 50-100 microns thick, although other thicknesses may be used. As noted above, the SSE slurry may be coated onto an aluminum foil 108 on one side and dried. In some implementation, the aluminum foil 108 may be between 10-30 microns thick, although other thicknesses may be used.

To produce the solid-state electrode laminate 102, the layers may be fed through a calender press device 104 in an Aluminum-SSE-Lithium-SSE-Aluminum layered stack. The calender press 104 may comprise a first roller 114 and a second roller 116 between which the solid-state electrode laminate 102 may be passed. The opposing cylindrical faces of the respective rollers 114, 116 exert a compressive force on the stack 102 to press or laminate the layers together. In one implementation, the pressure exerted on the stack 102 may reduce the porosity of the materials within the stack and cause the layers to bond. For example, the calender press 104 may cause the SSE layers 106 to bond to the lithium layer 110. In addition, the pressure exerted on the stack 102 may cause some layers to at least partially separate, such as the outer foil layers 108 to the SSE layers 106. The pressure applied to the stack 102 may correlate to a spacing between the first roller 114 and the second roller 116, among other factors such as temperature of the stack, which may be adjustable by a controller. For example, one or both of the calender rollers of the press 104 may be adjustable to increase or decrease the spacing between the rollers 114, 116. This densification of the stack 102 may cause the SSE layers 106 to press into the conductive layer 110 and generate adhesion between the layers. In addition, the adhesion between the SSE layers 106 and the respective carrier foil layers 108 may lessen such that the outer layer foil may be peeled from the pressed stack 102 in a controlled manner.

After calendering, the electrode stack 102 may be fed through a peeler 112 or peeling device. As described above, the calender press 104 may partially separate the SSE layers 106 from the outer foil layer 108 during the densification of the stack by the press. However, the outer foil layer 108 may at least partially remain on the stack such that the outer layer may be removed from the stack after pressing by the peeler 112. In some implementations, the peeler 112 may include an input side 120 into which the electrode stack, including the aluminum foil 108 outer layers, is fed. Within the peeler 112, the aluminum foil 108 layers may be peeled from or otherwise removed from the other layers of the stack 102. The peeler 112 may also include an output side 122 in which the electrode stack 102, without the outer aluminum layers 108, may exit. In particular, the electrode stack following the peeler 112 may include two SSE layers 106 and a lithium foil layer 110 arranged in an SSE-Lithium-SSE electrode stack configuration. The removed aluminum foil layers 108 may be peeled from the stack 102 by the peeler 112 and wound around one or more aluminum collectors 118. More particularly, the aluminum collectors 118 may be motorized or otherwise operated to rotate and apply a pulling force on the aluminum foil layers 108 to aid in peeling the layers from the stack 102. The peeler 112 may include structures, such as an upper peeling wedge and a lower peeling wedge described below, among others, that facilitates the removal of the foil 108 from the stack 102 in a manner that resists tearing the foil and/or damaging the layers of the stack as the aluminum layers are peeled from the stack. The peeled aluminum layers 108 may, in some instances, be unwound from the collectors 118 after collection and used again in generating other solid-state electrode laminate batches. Operation and configuration of the peeler 112 is discussed in more detail below. The output electrode stack comprises the SSE-Lithium-SSE compressed layers, which may be utilized as an anode in a solid-state battery or other possible uses. Other electrode compositions may also be manufactured using the same or similar system 100.

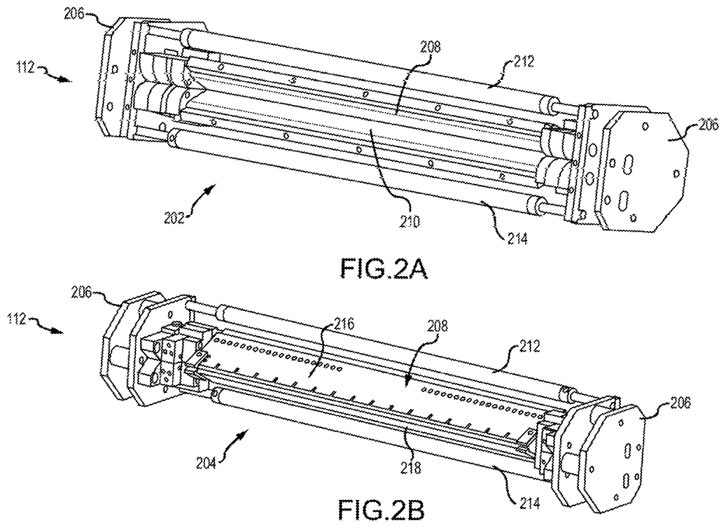

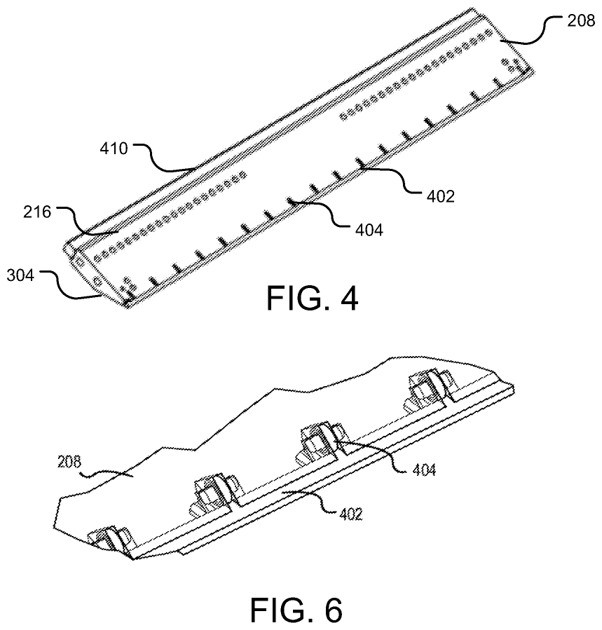

FIG. 2A is an isometric diagram illustrating an input side 202 of one possible implementation of a peeler 112 and FIG. 2B is an isometric diagram illustrating an output side 204 of the peeler. The peeler 112 may comprise inner and outer supporting assemblies including a mounting plate 206 on either end for mounting to a housing or other supporting structure. An upper peeling wedge 208, a lower peeling wedge 210, an upper guide roller 212, and a lower guide roller 214 may extend at least partially between supporting plates of the respective supporting assemblies on either side of the peeler 112. As described in more detail below, the upper peeling wedge 208 and the lower peeling wedge 210 are involved in peeling or separating the aluminum or other outer layer foil from the electrode stack 102. In particular, the upper peeling wedge 208 and the lower peeling wedge 210 provide support for the aluminum outer foil 108 as the foil is peeled from the electrode stack 102 to prevent the foil from tearing or damaging other layers of the electrode stack while being removed. In one example, the upper peeling wedge 208 and lower peeling wedge 210 may be oriented at an angle from the angle of entry of the electrode stack so as to reduce the pulling force on the stack as the outer layer 108 is pulled from the stack by the collectors 118. Further, a lifting roller (seen best in FIGS. 4-6) at an output end 204 of the each of the wedges 208, 210 may rotate as the aluminum foil 108 is pulled across the respective roller and provide a smooth transition for the foil as it is peeled from the stack 102. The electrode stack 102 described above, after exiting the calender press device 104, may pass between the upper wedge 208 and the lower wedge 210 through the input end 202 of the peeler 112. After peeling of the outer layer 108, the electrode stack 102 may exit the peeler 112 through the output end 204.

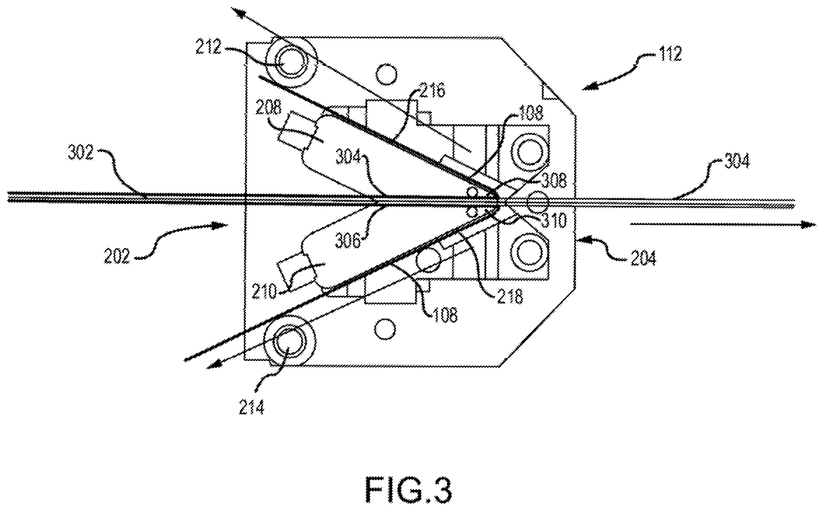

In general, the collectors 118 provide a pulling force on the outer foil layer 108 to pull the outer layer across an outer peeling surface 216, 218 of the corresponding upper or lower wedges 208, 210 and around the upper guide roller 212 or the lower guide roller 214. FIG. 3 illustrates a section view 300 of the peeling device 112 showing the peeling of the outer layers 108 of the stack 102. As shown, the unpeeled electrode stack 302 enters the peeler 112 at the input side 202 between the upper wedge 208 and the lower wedge 210. In particular, the unpeeled stack 302 may pass between a flat, feeding surface 304 of the upper wedge 208 and an opposing flat, feeding surface 306 of the lower wedge 210. The feeding surface 304 of the upper wedge 208 and the opposing feeding surface 306 of the lower wedge 210 may be spaced apart at a distance slightly more than the calendered thickness of the unpeeled electrode stack 302. In some implementations, the spacing between the feeding surfaces 304, 306 of the wedges 208, 210 may be adjustable, either manually or by a controlling computing device. The computing device controller may receive one or more inputs, such as inputs from a user via an input device, or from one or more sensors associated with the solid-state electrode laminate manufacturing system 100.

The outer foil layer 108 of the electrode stack 302 may be peeled off the stack at the output end 204 of the passage defined between the upper and lower planar 304, 306 surfaces of the respective upper wedge 208 and the lower wedge 210 in response to a pulling force applied to the aluminum foil by the collectors 118. However, pulling on the outer foil layer 108 with an excessive force may cause the foil to tear and/or damage the layers remaining in the stack 102 after peeling. Thus, the upper wedge 208 and the lower wedge 210 may be angled to reduce a pulling stress on the stack 102 at the peeling point. The upper wedge 208 and the lower wedge 210 may also include a lifting roller 308, 310 at the output end of the respective wedges to aid in transitioning the outer foil off of the stack 102. As the outer foil layer 108 is peeled from the stack, it may pass over the lifting roller 308, 310 at the output end of the wedges 208, 210 and be pulled along a peeling surface 216, 218 away from the electrode stack passing through the peeler 112. An upper outer foil layer 108 may be further pulled at least partially around the upper guide roller 212 and to a respective collector 118. A lower outer foil layer 108 may also be pulled at least partially around the lower guide roller 214 to a respective collector 118. The upper guide roller 212 and lower guide roller 214 may rotate as the foil is pulled around the respective rollers. In some instances, the upper guide roller 212 and the lower guide roller 214 may be motorized or otherwise controlled to rotate and provide an additional pulling force on the foil to peel the foil from the stack 102. Upon exiting the peeler 112 as guided by the upper guide roller 212 and the lower guide roller 214, the foil may be rolled onto one or more collectors 118, as shown in FIG. 1. The peeled electrode stack 304 may exit the peeler 112 through the output side 204 of the peeler. In one implementation, the peeled stack 304 may be carried on a conveyor belt and cut into desired lengths for use in a battery configuration.

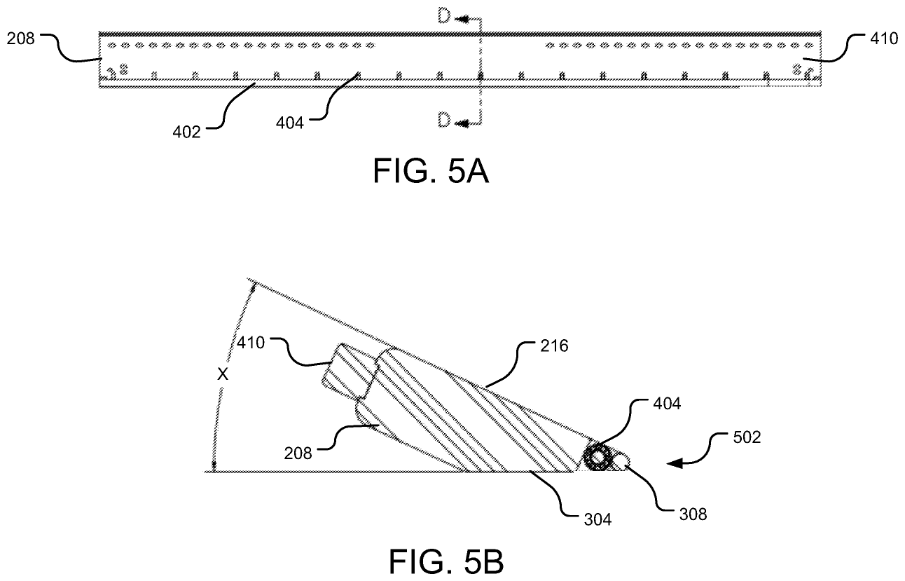

FIG. 4 is an isometric view of a wedge of the peeling device 112, FIG. 5A is a top view of the wedge, and FIG. 5B is a cross-section view of the wedge. In some implementations, the upper wedge 208 and the lower wedge 210 may be similar in design and composition. Thus, although discussed herein with reference to the upper wedge 208, it should be appreciated that the description may also apply to the lower wedge 210. As discussed above, the wedge 208 may extend at least partially between the mounting assemblies. On one side of the wedge 208 (and best seen in the cross-section view of the wedge 208 of FIG. 5B), the unpeeled electrode stack 102 is fed along a flat, feeding surface 304 toward an output end 502 of the wedge. The wedge 208 may also include an opposing angled or sloped surface 216 over which the peeled outer layer 108 is pulled away from the electrode stack 102. In some implementations, portions of the wedge 208, including the feeding surface 304 and the sloped surface 216, is a smooth low friction surface. In one example, the surfaces may be a plastic-based material to provide the low-friction surface for the electrode stack 102 and peeled outer layer 108 to slide across. The wedge 208 may include a supporting rod 410 extending along an outer edge of the wedge to provide structural support to the wedge and anchor the wedge to the mounting assemblies 206.

At the output end 502, the wedge 208 may include a lifting roller 308. The lifting roller 308 may comprise a circular rod extending along the length of the wedge 208 that rotates as the peeled outer layer is pulled across the roller. In some instances, the lifting roller 308 may be in communication with a motor or other device to rotate the lifting roller. In other embodiments, the lifting roller 402 may be allowed to freely rotate in response to the outer foil layer 108 of the stack 102 being pulled around the lifting roller. For example, the collectors 118 may wind the outer foil layer 108 as the layer is peeled from the electrode stack 102. This winding may pull the outer foil layer from the stack, partially around the lifting roller 308 and across the peeling surface 216. The lifting roller 308 may rotate in response to the foil layer being pulled from the stack and along the peeling surface 216. This rotation of the lifting roller 308 may ease the transition of the outer foil layer 108 from the stack and onto the peeling surface 216 such that tearing of the layer does not occur or is otherwise minimized as the layer is peeled. Without the lifting roller 308, the pulling force on the peeled outer layer may be too great that damage to the layer or the remaining layers of the electrode occurs. In some instances, a diameter of the lifting roller 308 may be selected to minimize the pulling forces on the outer foil layer 108 at the point of peeling and safely transition the foil layer from the stack and onto the wedge 216.

Adjacent to the lifter roller 402 is one or more support rollers 404 located at least partially between the feeding surface 304 and the peeling surface 216 of the corresponding wedge 208. In one particular implementation, the support rollers 404 do not contact the electrode stack 102 or the peeled outer layer 108, but instead provides structural and rotational support for the lifting roller 308. In one implementation, the wedge 208 may include 18 support rollers, although more or fewer such rollers may be included along the wedge. The support roller 404 may be spaced equidistant from each other toward the output edge 502 of the wedge, adjacent to and in contact with the lifter roller 402. As shown in FIG. 6, each support roller 404 be in contact with the lifting roller such that, as the lifting roller rotates in a counter-clockwise direction, the support rollers 404 may rotate in a clockwise direction. In one implementation, the support rollers 404 provide structural support for the lifting roller 402. In addition, the support rollers 404 may be connected to a motorized mechanism that causes the support rollers to rotate in a particular direction, thereby driving the lifting roller 402 to rotate in the opposite direction to decrease the pulling forces on the outer foil at the point of peeling. In other implementations, the rotation of the support rollers 404 is in response to the rotation of the lifting roller 402 as the outer layer foil 108 is pulled across the lifting roller, as described above.

Returning to the cross-section view of the wedge in FIG. 5B, the feeding surface 408 and the sloped surface 406 may define an angle x. In one particular implementation, angle x is 15 degrees. In other implementations, angle x may range from 10 degrees to 25 degrees. Regardless, the angle aids the wedge 208 in lifting the outer foil layer 108 from the electrode stack 102 in a manner that prevents damage to the inner conductive layer 110. Wedges with angles that are too high or too low may damage the conductive foil layer 110 when the collectors 118 or other mechanisms pull the outer foil layer 108 away from the electrode stack 102.

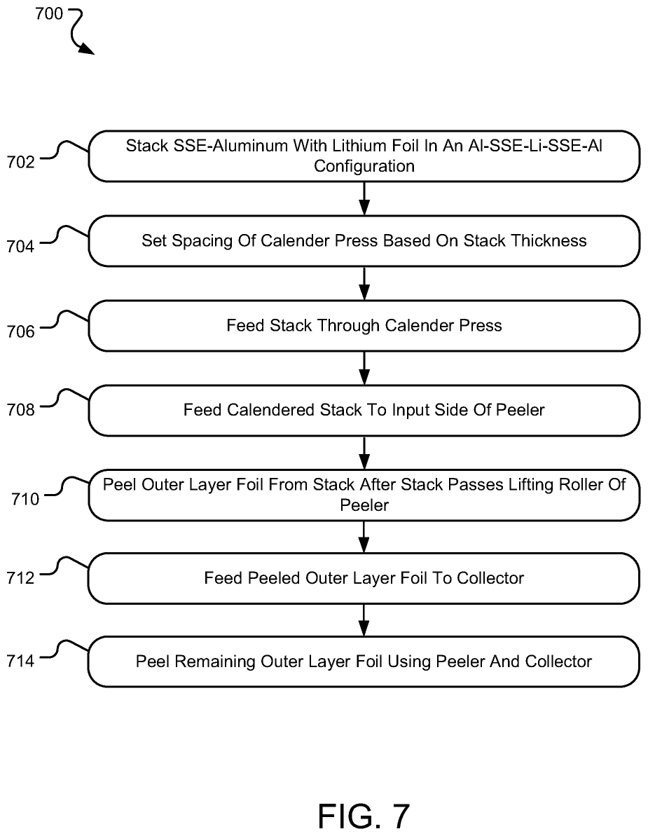

FIG. 7 is a flowchart of a method 700 for manufacturing a solid-state electrode laminate using a peeling device, according to aspects of the present disclosure. The peeler device 112 described is one such peeling device that may be utilized with the method 700 of FIG. 7. Beginning at step 702, a solid-state electrolyte may be cast onto a metal foil, as described above. In one implementation, the metal foil may be an aluminum foil, although other types of foils may be used. The cast aluminum-SSE layers may be stacked with a lithium foil 110 in an Aluminum-SSE-Lithium-SSE-Aluminum (Al-SSE-Li-SSE-Al) configuration. In some instances, the center conducting 110 layer of the stack may comprise other types of conducting material, such as graphite or silicon.

The stacked configuration may be fed through a calender press 104 to laminate the SSE layers 106 onto the lithium foil 110 layer. Thus, at step 704, a spacing of the calender press 104 may be set. In one implementation, the spacing may be manually set by an operator of the press 104. In another implementation, the spacing may be controlled by a calender press controller based on one or more inputs. Further, the spacing of the calender press 104 may be based on the thickness of the stack 102 of materials or on the thickness of any or more of the layers of the stack. At step 706 and following the setting of the spacing of the press 104, the stack 102 may be fed through the calender press for laminating the SSE layers 106 to the lithium foil 110.

At step 708, the calendered electrode stack 102 may be fed into the input side 202 of the peeler 112. In particular, the calendered stack 102 may be fed between the upper wedge 208 and the lower wedge 210 of the peeler 112 until a forward edge of the stack extends out from the between the wedges on the output side 204 of the peeler. At step 710, the outer layer foil 108 may be peeled from the stack that extends from the output side 204 of the wedges 208, 210. In some implementations, the outer layer foil 108 may be initially peeled from the stack manually to start the peeling process. In other implementations, the peeler 112 may include an edge or other mechanism that begins peeling the outer foil 108 from the stack 102. As mentioned above, the calendering of the stack may at least partially separate the outer foil 108 from the SSE layer 106 to aid in the initial separation. Further, the peeling of the outer foil layer 108 may occur on both the top outer layer and the bottom layer, or on either the top layer or the bottom layer. In general, although discussed herein for the peeling of an outer foil layer 108 of the stack 102, the operations of the method 700 may apply to either or both of the upper outer foil layer or the bottom foil layer.

At step 712, the peeled outer layer foil 108 may be fed to and wound around a collector 118, such as a collector spool for accumulating the peeled foil from the peeler 112. In particular, the peeled outer layer foil 108 may be pulled across the sloped surface 406 of the respective wedge 208, 210, around the respective guide roller 212, 214, and out of the peeler 112 to a respective foil collector 118. The feeding of the foil 108 to the collector 118 may be performed manually or through a feeding mechanism that routes the peeled outer layer foil to a collector. At step 714, the peeler 112, as well as the collector 118 in some instances, may be operated to peel the remaining outer foil layer from the calendered stack 102. In particular, the collector 118 may generate tension on the outer foil 108 to pull the foil from the stack 102. As described above, the lifting roller 402 at the output side of the wedges 208. 210 may gently guide the pulled foil from the stack 102 and onto the sloped surface 406 without tearing the foil or damaging the remaining layers of the stack. In other words, the lifting roller 402 and the angle of the wedge provide a smooth lifting motion on the outer foil layer 108 that resists tearing of the foil or damaging the remaining stack layers 110. As the outer foil layer 108 is peeled, the remaining layers may pass out of the peeler 112 for cutting into appropriate lengths for use in a battery configurations.

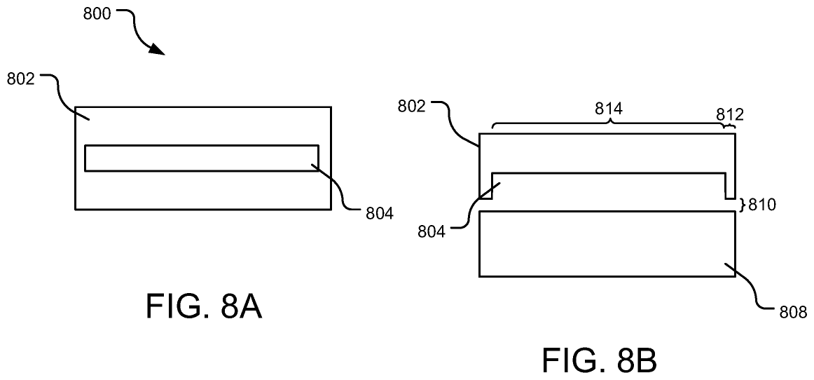

Another implementation of a solid-state electrode laminate 102 manufactured using a notched calender press device 104 is illustrated in FIGS. 8A-8B. In particular, FIG. 8A illustrates a front view of an alternate calender roller 802 and FIG. 8B illustrates a cross-section view of two alternate calender rollers 802, 808. One of the rollers 802, 808 may include at least one notch 804 spanning a portion of the length the roller. For example, an upper roller 802 may include a notch 804 in the surface of the roller along a portion of the length of the upper roller. Although the upper roller 802 is illustrated as including one notch 804, each of the upper roller or the lower roller may have no notch or multiple notches. As above, the rollers 802, 808 may be oriented such that an adjustable spacing 810 is between the upper and lower rollers. In general, the radius on the outer corner of the notch 204 should be sharp enough such that a clean break with the layers of the stack is achieved, but not so sharp that the notch edge is fragile or irregular.

During pressing, the notch 804 of the roller 802 may provide a corresponding portion of the laminate stack 102 over which the layers are not pressed or the pressure is reduced on the stack such that the layers are not laminated. For example and with reference to FIG. 1, as the layers of the stack 102 are fed through the calender press 104, the upper roller 114 may rotate in a counter-clockwise direction and the lower roller 116 may rotate in a clockwise direction to feed the stack 102 through the spacing and compress the stack layers. However, the rollers 114, 116 in this example may have a solid outer surface such that a constant pressure is applied to the stack 102 within the spacing between the rollers. In contrast, the notch 804 of the upper or lower roller of FIGS. 8A and 8B may provide a portion of the roller in which pressure is not exerted or reduced onto the stack 102 as it passes between the rollers. For example, in FIG. 8B, the notch 804 of the upper roller 802 may be such that the rollers do not apply a laminating pressure to the stack 102 as the notch aligns with the outer layer of the stack. As the roller 802 rotates as more of the stack is fed between the rollers, the notch 804 may rotate away from the center of the spacing 810 and a laminating pressure may again be exerted on the stack 102.

As shown, the notch 804 in the calender rollers 802, 808 generally does not extend the full length of the roller. The notch 804 may extend less than the full length of the roller 802 to ensure that at least a portion of the upper roller 802 and the bottom roller 808 are in contact with upper and lower carrier foils 108 of the laminate during the lamination process described above. By providing this constant contact with the stack 102, a constant or near constant tension may be maintained on the stack as it is pulled through the calender press 114. If the notch 804 spans the full width of the roller 802, contact between the rollers 802, 808 may be lost and the tension on the stack 102 may drop when the notch in roller 802 faces the roller 808. The width of the notch/gap (814) or the width of the roller that expends past the edge of the notch/gap (812) may be any length such that width 812 is wide enough to prevent deformation of the stack 102 while under the lamination pressure, but is not too wide that the carrier foil 108 can be removed from the separator layer 106 during the peeling process.

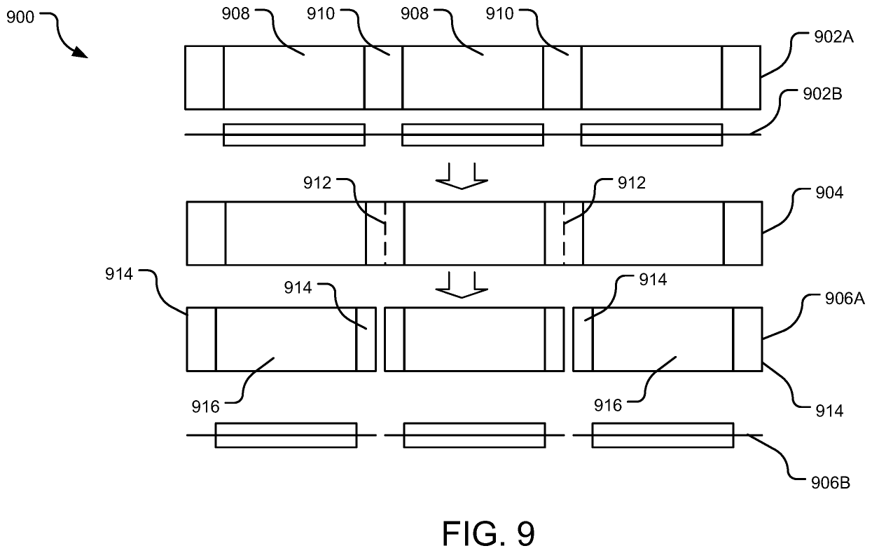

FIG. 9 illustrates top views and side views of solid-state electrode laminates with cut-out portions 910 for separate laminated sections manufactured using a notched calender press, such as that illustrated in FIGS. 8A and 8B. As described above, the roller 802 of a calender press 800 may include a notch 804 in the outer surface such that a laminating pressure is reduced on the electrode stack 102 when the notch portion of the roller is adjacent to the stack as the stack is fed through the calender press. Electrode laminate 902 of FIG. 9 is an illustrated top view and 902B is a side view of the electrode stack that results from using the notched roller 802. The electrode laminate 902 comprises a series of alternating laminated portions 908 and non-laminated portions 910. The laminated portions 908 of the electrode stack 902 coincide with the outer surface of the roller 802 of the calender press that applies a laminating pressure to the stack. In other words, as the electrode stack 102 is fed through the press 104, the portions of the roller 802 without the notch 804 may apply the laminating pressure onto the stack, resulting in the layers adhering together as explained above. Thus, the laminated portions 908 include the laminated Aluminum-SSE-Lithium-SSE-Aluminum stack, from which the aluminum outer foil layers may be removed to generate the laminated SSE-Lithium-SSE electrode. The non-laminated portions 910 of the electrode stack 902 coincide with the notch 804 portion of the roller 802. In particular, as the electrode stack 102 is fed through the press 104, the portions of the roller 802 with the notch 804 may not apply the laminating pressure onto the stack. As these sections 910 of the electrode stack 902 are not pressed by the roller 802, the SSE layers 106 of the stack 102 are not laminated onto or otherwise adhered to the lithium foil 110 layer. Removal of the aluminum layer 108 from the stack 102 may also remove the SSE layer 106 such that the lithium foil layer 110 is exposed in the section 910. The removal of the SSE layer 106 from the lithium layer 110 at sections 910 of the stack 902 may occur on both sides of the stack, although only one side is shown in FIG. 9. As should be appreciated, the width of the exposed sections 910 may coincide to the width of the notch 804 of the roller 802. In this manner, the width of the exposed sections 910 may be controlled through a selection of a width of a roller 802 of the calender press 104. The width of the exposed portions 910 may also be based on a diameter of the notched roller 802, with larger diameters generating wider exposed sections and smaller diameters generating shorter exposed sections.

The exposed 910 portions of the stack 902 may form conductive tabs of a battery electrode, such as an anode. For example, the stack 902 illustrated in FIG. 9 may be cut along the dotted lines 912 of stack 904 and separated as illustrated in stack 906A (top view) and 906B (side view) to create multiple electrodes comprising a laminated portion 916 with lithium exposed tabs 914 on either end. The tabs 914 are conductive to the lithium foil layer 110 of the stack such that the electrode may be connected to other electrical components. For example, a load may be connected to a tab 914 of the electrode for receiving a power signal from the electrode when connected within a battery configuration. Through the use of the notched roller 802, multiple solid-state electrode laminates may be generated from a single stack 102 and the manufacturing process described above, with conductive tabs 914 on each end of the electrode laminates. The notched roller 802 allows for easy removal of the SSE layer 106 from the lithium layer 110 (at sections 910) as the SSE layer is not adhered to the lithium layer.

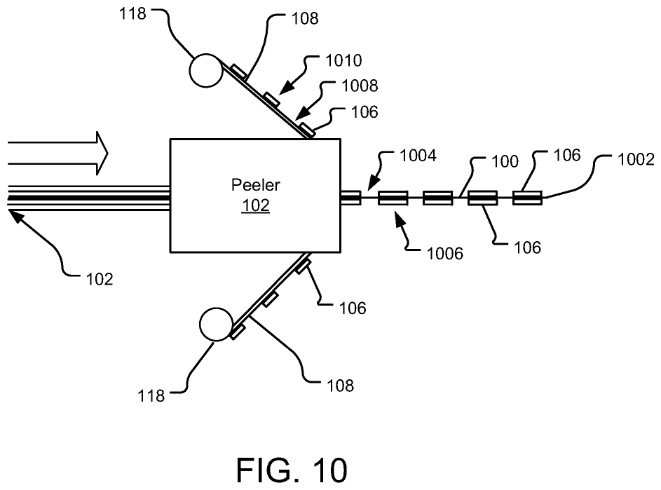

The peeler 112 described herein may also be utilized in a solid-state laminated electrode manufacturing process with a notched calender press as described above. In particular, FIG. 10 is a diagram illustrating manufacturing a solid-state electrode laminate 1002 with notched sections 1004 using the peeling device 112. As noted above, a calender press 104 using notched rollers 802, 808 may create an electrode stack with alternating sections of bare conductive foil 1004 sections 1004 and SSE-conductive foil-SSE sections 1006. The peeler 112 described herein may be utilized in such processes to remove the outer foil layer 108 of the pressed stack 102 as described above, while also removing the portions SSE 106 that are not laminated to the conductive foil 110. For example, the peeler 112 may pull on the outer foil layer 108 of the electrode stack 102 as described above to peel the outer foil from the stack. However, at those sections 1004 in which the notch of the calender press roller 802 is adjacent to the stack, the laminating pressure is not provided to the stack such that the SSE layer 106 over those portions is not adhered to the conductive foil layer 110 and remains stuck to the outer foil layer 108. When the outer foil layer 108 is peeled from the stack 102 as described above, the portions of the SSE 106 that remain adhered to the outer foil 108 may be lifted away from the conductive foil layer 110. The stack 1002 output from the peeler 112 in this instance would comprise alternating portions of SSE-conductive foil-SSE sections 1006 and bare conductive foil portions 1004.

The peeling of the outer foil layer 108 may follow the same path to a collector 118 as described above. However, in this instance, the peeled outer foil 108 may include alternating portions of bare foil 1008 and portions 1010 of outer foil and SSE layer 106. The portions 1010 including the SSE material 106 may correspond to the portions of the peeled stack 1002 of bare conductive foil 1004. In other words, the SSE layer 106 that is not laminated to the conductive layer 110 by the notched press 104 may also be removed from the stack 102 as the outer foil 108 is peeled by the peeler 112. The collector 114 may similarly be configured to collect both the portions 1008 of bare outer layer foil 108 and the portions 1010 of outer layer foil and SSE 106. As such, the peeler 112 may operate to peel the outer layer 108 and potentially other layers from the stack 102 in the same manner regardless of the type of calender press 104 utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A peeling device for manufacturing a battery electrode, the device comprising:
an upper peeler comprising an upper lifting roller on an output side of the upper peeler, the upper lifting roller rotating in a first direction to lift an upper foil layer away from a laminated electrode stack; and
a lower peeler oriented opposite the upper peeler and comprising a lower lifting roller on an output side of the lower peeler rotating in a second direction, opposite the first direction, to lift a lower foil layer away from the laminated electrode stack.

2. The peeling device of claim 1 wherein the upper peeler and the lower peeler each comprise a substantially flat feeding surface, the laminated electrode stack fed between the feeding surface of the upper peeler and the lower peeler.

3. The peeling device of claim 2 wherein the upper peeler further comprises a sloped peeling surface opposite the feeding surface, the upper foil layer pulled along the peeling surface after lifted away from the laminated electrode stack.

4. The peeling device of claim 3 wherein the peeling surface and the feeding surface of the upper peeler define a peeling angle.

5. The peeling device of claim 4 wherein the peeling angle is between 10 degrees and 25 degrees.

6. The peeling device of claim 1 wherein the upper peeler and the lower peeler are a low-friction construction material.

7. The peeling device of claim 1 wherein the upper peeler further comprises:
a support roller adjacent the lifting roller, the support roller rotating in a direction opposite the first direction in response to the rotation of the lifting roller.

8. The peeling device of claim 1 further comprising:
an upper collector receiving the lifted upper foil layer, wherein rotation of the upper collector the upper foil layer from the upper peeler.

9. The peeling device of claim 1 further comprising:
a first mounting plate and a second mounting plate, the upper peeler extending between the first mounting plate and the second mounting plate.

10. The peeling device of claim 1 wherein the laminated electrode stack comprises the upper carrier layer, an upper solid-state electrolyte (SSE) layer, a conductive foil, a lower SSE layer, and the lower carrier layer.

11. The peeling device of claim 10 wherein the laminated electrode stack is received from a pressing device that laminates the upper SSE layer and the lower SSE layer to the conductive foil while separating the upper carrier layer from the upper SSE layer and the lower carrier layer from the lower SSE layer.

12. A method for a battery electrode, the method comprising:
laminating an electrode stack comprising a plurality of layers using a pressing device, wherein the pressing device laminates a first solid-state electrolyte (SSE) layer and a second SSE layer to a conductive foil; and
continuously pulling the laminated electrode stack through a peeling device, the peeling device removing from the laminated electrode stack a first carrier film from the first SSE layer and a second carrier film from the second SSE layer.

13. The method of claim 12 wherein the pressing device is a calender press comprising a first roller and a second roller, the first roller oriented above the second roller and separated by a pressing gap.

14. The method of claim 13 wherein at least of the first roller or the second roller comprises a notch portion in an outer surface of roller, the notch portion removing a laminating pressure on the electrode stack when adjacent to the electrode stack.

15. The method of claim 14 further comprising:
removing, using the peeling device, the first SSE layer from the conductive foil at the unlaminated portions of the electrode stack due to the notch portion of the roller.

16. The method of claim 12 further comprising:
collecting the first carrier film on a collecting spool after the first carrier film is removed from the electrode stack.

17. A system for manufacturing a battery electrode, the system comprising:
a pressing device partially separating, through pressure applied to an electrode stack, a carrier film from a solid-state electrolyte (SSE) layer of the electrode stack;
a peeling device comprising a lifting roller removing the partially separated carrier film from the SSE layer in a continuous piece; and
a collector collecting the peeled carrier film in the continuous piece.

18. The system of claim 17 wherein the peeling device further comprises:
a planar surface along which the electrode stack is pulled; and
a sloped surface opposite the planar surface along which the peeled carrier film in the continuous piece is pulled along at least partially by a pulling force from the collector.

19. The system of claim 18 wherein the lifting roller comprises:
a shared edge of the planar surface and the sloped surface, the lifting roller in contact with the carrier film and rotating to apply a lifting force on the carrier film to peel the carrier film from the SSE layer.

20. The system of claim 18 wherein the sloped surface is angled relative to the planar surface, the angle of the sloped surface selected to maintain the peeled carrier film in the continuous piece as the carrier film is separated from the SSE layer.
